(19) United States
(12) Patent Application Publication
(10) Pub. No.: US 2005/0001593 A1
(43) Pub. Date: Jan. 6, 2005

(54) Method of charging and discharging a plurality of batteries

(76) Inventors: Atsushi Kawasumi, Mihara-gun (JP); Shinichi Itagaki, Sumoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/854,366

(22) Filed: May 27, 2004

(30) Foreign Application Priority Data
May 30, 2003 (JP) 155708/2003

(51) Int. Cl. H02J 7/00

(52) U.S. Cl. 320/132

(57) ABSTRACT

The method of charging a plurality of batteries successively switches to, and charges a plurality of batteries one at a time. Batteries are charged by constant current until battery voltage reaches a prescribed voltage, or battery capacity reaches a prescribed capacity. After that, voltage limited charging is performed while regulating battery voltage. In the method of discharging a plurality of batteries, the discharging battery is discharged until remaining capacity drops below a minimum capacity, or battery voltage drops below a minimum voltage. The battery being discharged is then switched to supply power to battery powered electrical equipment from another battery with remaining capacity greater than the minimum capacity, or battery voltage greater than the minimum voltage.

### BACKGROUND OF THE INVENTION

This invention relates to a method of successively switching to, and charging a plurality of batteries, and to a method of successively switching to, and discharging a plurality of batteries to supply power to electrical equipment using battery power.

Battery powered electrical equipment, which houses a spare battery in addition to a main battery, can still be used after complete discharge of the main battery by switching to the spare battery. Battery powered electrical equipment housing a plurality of batteries has been developed to extend usable time. (Refer to reference 1: Japanese Patent Application HEI10-16869, 1998.)

Japanese Patent Application HEI10-16869 (1998) describes a method of charging and discharging a plurality of batteries which simultaneously charges the batteries and switches to successive batteries for use. A method which simultaneously charges a main and spare battery has the characteristic that both batteries can be fully charged in a short time. However, charging current is large at twice that for a single battery, use of a high capacity battery charger is required, and the battery charger becomes large and expensive. To resolve these kinds of drawbacks, a charging method successively switches to, and charges a plurality of batteries.

### SUMMARY OF THE INVENTION

This charging method can successively charge a plurality of batteries with a small capacity battery charger designed to charge a single battery. Therefore, the battery charger can be made small and inexpensive. However, this method of charging and discharging takes time to fully charge all batteries. This is because the time to charge all batteries is equal to the time to charge one battery times the number of batteries.

Batteries are sometimes used after charging for a limited time, and after interrupting charging. Specifically, instead of taking the time to charge all batteries to full charge, the batteries are used after interrupting charging prior to reaching full charge. In this case it is important to be able to use the batteries for as long as possible with a short charging time. For example, if charging time is limited to half the time required to charge all batteries to full charge, and if all batteries can be charged to greater than 50% capacity in that time, the method has the characteristic that batteries can be used for a long time after a short, limited time charge.

The present invention was developed to realize this as its first object. Thus it is a primary object of the present invention to provide a method of charging a plurality of batteries which increases charge capacity with a limited charging time without increasing the capacity of the battery charger.

When a battery is charged in a high temperature environment, the temperature of the battery itself can become abnormally high. This is because heat is generated internally when a battery is charged. If a battery becomes abnormally hot, battery performance drops. Therefore, when battery temperature becomes abnormally high, it is necessary to suspend charging and cool the battery. Since charging cannot be performed when the battery is being cooled, this situation has the drawback that total charging time increases.

The second object of the present invention is to resolve this drawback. Thus it is the second object of the present invention to provide a method of charging a plurality of batteries which charges continuously while minimizing battery temperature rise, and can effectively prevent heat damage while reducing charging time to full charge for all batteries in a high temperature environment.

In battery powered electrical equipment, such as a laptop computer, which houses a plurality of batteries, when the remaining capacity of the battery being used becomes low, the battery is switched for continuous operation. However, it may become impossible to discharge the battery being used prior to completing the switch to the next battery. In this case, electrical equipment such as a laptop computer will shut-down during the battery switch and continuous operation becomes impossible.

For example, this condition can develop when a laptop computer is used in the following fashion. The laptop computer houses a first and second battery. Assume the remaining capacity of the first battery is 0% and the remaining capacity of the second battery is 80%. Further, an AC adapter is connected to the laptop computer, the AC adapter is charging the first battery, and power is being supplied to the laptop computer from the first battery while it is being charged. Assume now that the AC adapter is unplugged prior to sufficiently charging the first battery; namely the remaining capacity of the first battery is essentially 0%. Since remaining capacity of the first battery is low, the laptop computer will try to switch its power source from the first battery to the second battery. However, since there is essentially no remaining capacity in the first battery, the laptop computer cannot continue to operate, and it shuts-down before the batteries can be switched. Here, even though there is remaining capacity in the second battery and the laptop computer could be operated from that battery, the laptop computer shuts-down before the batteries can be switched.

The third object of the present invention is to resolve this drawback. Specifically, it is the third object of the present invention to provide a method allowing discharge of a plurality of batteries while effectively preventing battery powered electrical equipment from becoming unusable when remaining capacity of any battery becomes low.

The above and further objects and features of the invention will more fully be apparent from the following detailed description with accompanying drawings.

The method of charging a plurality of batteries of the present invention is a method which includes a step to successively switch to, and charge each individual battery one at a time. Batteries are charged by constant current until battery voltage reaches a prescribed voltage. Subsequently, batteries are charged by voltage limited charging while regulating battery voltage. In this charging method, if the voltage of the first battery to be charged is below the prescribed voltage, that battery is charged by constant current charging until battery voltage reaches the prescribed voltage. When the voltage of a battery being charged by constant current reaches the prescribed voltage, charging is switched to the next battery, and that battery is charged by constant current until the prescribed voltage is reached. The battery being charged by constant current is switched from one to the next until the voltages of all batteries have reached the prescribed voltage. Subsequently, charging switches from constant current charging to voltage limited charging to reach full charge.

The method of charging a plurality of batteries of the present invention is also a method which includes a step to successively switch to, and charge each individual battery one at a time based on remaining battery capacity. Batteries are charged by constant current until remaining battery capacity reaches a prescribed capacity. Subsequently, batteries are charged by voltage limited charging while regulating battery voltage. In this charging method, if the remaining capacity of the first battery to be charged is below the prescribed capacity, that battery is charged by constant current charging until battery capacity reaches the prescribed capacity. When the capacity of a battery being charged by constant current reaches the prescribed capacity, charging is switched to the next battery, and that battery is charged by constant current until the prescribed capacity is reached. The battery being charged by constant current is switched from one to the next until the capacities of all batteries have reached the prescribed capacity. Subsequently, charging switches from constant current charging to voltage limited charging to reach full charge.

The method of charging a plurality of batteries described above has the characteristic that battery capacity resulting from charging for a limited time can be made large without making the capacity of the battery charger large. Therefore, this charging method has the characteristic that batteries can be charged for a short time and used for a long time. This is because the charging method of the present invention does not successively charge each battery to full charge, but rather successively switches to, and efficiently charges all batteries with high current via constant current charging until each battery voltage has reached a prescribed voltage or each remaining battery capacity has reached a prescribed capacity.

Further, the charging method of the present invention detects battery temperature and switches the battery being charged when battery temperature reaches a maximum temperature.

The charging method above has the characteristic that batteries can be continuously charged while reducing battery temperature rise, and heat damage can effectively be prevented while reducing the time to fully charge all batteries in a high temperature environment. This is because battery temperature is detected, and the battery being charged is switched when battery temperature reaches a maximum temperature.

The method of the present invention is a charging method which includes a step to successively switch to, and charge each battery one at a time, and by suspending charging to the first battery being charged before it reaches full charge, switching to the next battery, and commencing charging of that battery, the method switches charging from one battery to the next and charges all batteries to a state preceding to full charge.

This charging method successively switches to, and charges each of a plurality of batteries one at a time. It suspends charging to the first battery being charged before it reaches full charge, switches to the next battery and begins charging that battery. The method charges by switching the battery being charged from one to the next. Specifically, one battery is not continuously charged until it reaches full charge, but rather charging is performed while switching the battery being charged. Therefore, even when time is not available to fully charge all batteries, that is even when partial charging to a state preceding full charge is performed, this method has the characteristic that the total charge capacity attainable by all batteries can be increased.

The method of discharging a plurality of batteries of the present invention supplies power to battery powered electrical equipment by successively discharging the plurality of batteries one at a time. In this method of discharging, when remaining battery capacity of the battery supplying power to the electrical equipment drops below a minimum capacity, or the battery voltage drops below a minimum voltage, power is supplied to charge the discharging battery, which supplies power to the electrical equipment, from another battery which has a remaining capacity greater than the minimum capacity or battery voltage greater than the minimum voltage.

The method of discharging a plurality of batteries described above has the characteristic that inability to use battery powered electrical equipment due to an event such as shut-down can be effectively prevented when remaining capacity of the battery supplying power to the electrical equipment becomes low. This is because when remaining battery capacity of the discharging battery supplying power to the electrical equipment drops below a minimum capacity, or battery voltage drops below a minimum voltage, power is supplied to charge the discharging battery, which supplies power to the electrical equipment, from another battery which has a remaining capacity greater than the minimum capacity or battery voltage greater than the minimum voltage.

### BRIEF DESCRIPTION OF THE DRAWINGS

FIG. 1 is a block diagram of a power supply circuit used in an embodiment of the method of charging and discharging a plurality of batteries of the present invention.

FIG. 2 is a graph showing the relation between battery capacity and charging time when one battery is charged to full charge and subsequently the next battery is charged to full charge.

FIG. 3 is a graph showing the relation between battery capacity and charging time when two batteries are charged by an embodiment of the charging method of the present invention.

FIG. 4 is a graph showing battery temperature variation over time when two batteries are charged by an embodiment of the charging method of the present invention.

### DETAILED DESCRIPTION OF THE INVENTION

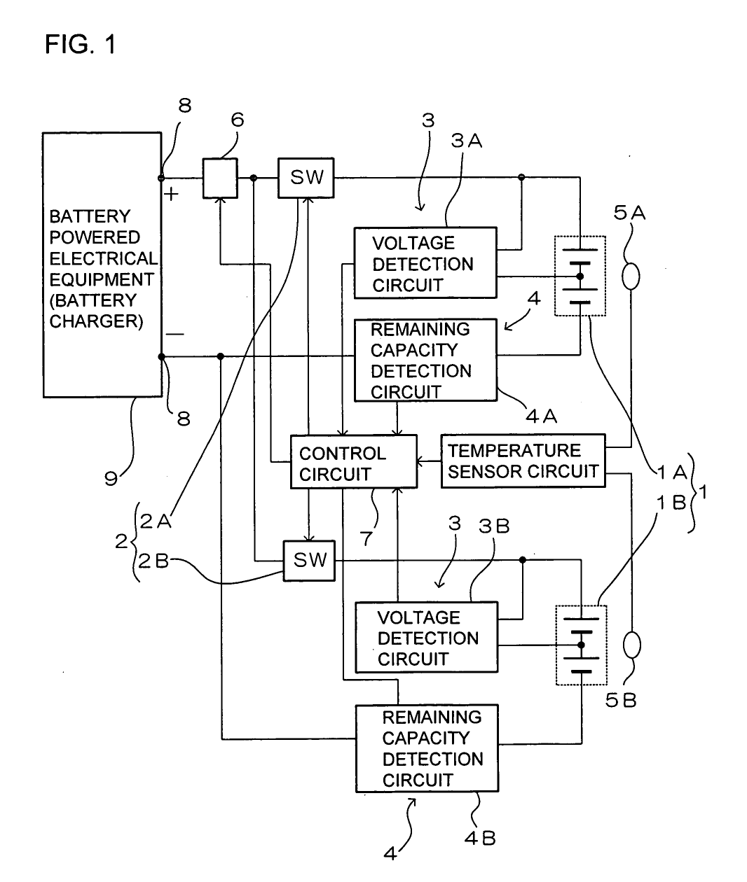

FIG. 1 shows a power supply circuit which switches to, and charges as well as discharges a first battery 1A and a second battery 1B, which are a plurality of batteries 1. This power supply circuit is provided with a constant current, voltage limited charging circuit 6 which charges batteries 1 by constant current charging or voltage limited charging, a first battery 1A and a second battery 1B, a first switch 2A and a second switch 2B connecting each battery 1 to an output terminal 8, a first voltage detection circuit 3A and a second voltage detection circuit 3B which detect the voltage of each battery 1, a first remaining capacity detection circuit 4A and a second remaining capacity detection circuit 4B which compute the remaining capacity of each battery 1, a first temperature sensor 5A and a second temperature sensor 5B which detect the temperature of each battery 1, and a control circuit 7 which controls the constant current, voltage limited charging circuit 6, switches the first switch 2A and a second switch 2B ON and OFF to switch the battery 1 being charged or discharged, or controls one battery 1 to charge the other battery 1 based on signals input from the first voltage detection circuit 3A and second voltage detection circuit 3B, the first remaining capacity detection circuit 4A and second remaining capacity detection circuit 4B, and the first temperature sensor 5A and second temperature sensor 5B.

In the power supply circuit of FIG. 1, the control circuit 7 controls the first switch 2A and the second switch 2B ON and OFF. During charging, the control circuit 7 turns either one of the switches 20N and the other switch 2 OFF to charge the battery 1 connected to the ON switch 2. The battery 1 being charged is switched by changing the switch 2 which is ON. In addition, during discharging, the control circuit 7 turns either one of the switches 20N and the other switch 2 OFF to discharge the battery 1 connected to the ON switch 2. The battery 1 being discharged is switched by changing the switch 2 which is ON. Further, when charging one battery 1 with the other battery 1, the first switch 2A and the second switch 2B are turned ON, and the battery 1 with higher remaining capacity charges the battery 1 with lower remaining capacity.

The control circuit 7 of the power supply circuit of this figure also controls the constant current, voltage limited charging circuit 6 to charge the battery 1 with constant current charging or with voltage limited charging. The control circuit 7 controls the constant current, voltage limited charging circuit 6 depending on battery voltage or remaining battery capacity to switch battery 1 charging conditions between constant current charging and voltage limited charging. Battery voltage is input to the control circuit 7 from the voltage detection circuit 3, and remaining battery capacity is input to the control circuit 7 from the remaining capacity detection circuit 4. When the voltage of the battery 1 being charged is less than the prescribed voltage, or when remaining battery capacity is less than the prescribed capacity, the control circuit 7 controls the constant current, voltage limited charging circuit 6 to charge the battery 1 with constant current charging. When battery voltage becomes greater than the prescribed voltage, or when remaining battery capacity becomes greater than the prescribed capacity, the control circuit 7 controls the constant current, voltage limited charging circuit 6 to charge the battery 1 with voltage limited charging.

The power supply circuit shown in FIG. 1 is suitable for batteries 1 which are lithium ion batteries. However, batteries may also be rechargeable batteries other than lithium ion batteries such as nickel hydrogen batteries or nickel cadmium batteries. To fully charge lithium ion batteries while preventing battery performance degradation, batteries are charged by constant current charging until battery voltage reaches the prescribed voltage. When battery voltage reaches the prescribed voltage, batteries are charged by voltage limited charging while regulating battery voltage. This method can fully charge lithium ion batteries without degrading their performance. However, nickel hydrogen batteries or nickel cadmium batteries can also be fully charged by this method while minimizing their performance degradation.

The prescribed voltage, at which the control circuit 7 controls the constant current, voltage limited charging circuit 6 to end constant current charging, is set to an optimum voltage depending on the type of the battery 1. This prescribed voltage is set to a voltage which will not degrade battery performance while batteries 1 are rapidly charged in a short time. For example, in the case of lithium ion batteries, prescribed voltage is set to 4.1V to 4.3V. In the case of nickel hydrogen batteries or nickel cadmium batteries, it is set to 1.5V to 2.0V. The prescribed voltage is stored in a control circuit 7 memory circuit (not illustrated).

The switch from constant current charging to voltage limited charging can also be executed by detecting remaining battery capacity rather than battery voltage. This method detects remaining capacity of the battery 1 being charged with the remaining capacity detection circuit 4, and switches constant current charging to voltage limited charging when the detected remaining capacity increases to the prescribed capacity. The remaining capacity detection circuit 4 computes remaining capacity by subtracting the 1 discharge capacity from charge capacity. Charge capacity is computed from the integrated value of charging current, and discharge capacity is computed from the integrated value of discharging current. The prescribed capacity for switching charging conditions is set to an optimum remaining capacity depending on the type of the battery 1. This prescribed capacity is set to a remaining capacity which will not degrade battery performance while batteries 1 are rapidly charged in a short time. For example, in the case of lithium ion batteries, prescribed capacity is set to 60% to 80% of the full charge capacity. In the case of nickel hydrogen batteries or nickel cadmium batteries, it is set to 80% to 90% of the full charge capacity. The prescribed capacity is stored in a memory circuit (not illustrated) in the control circuit 7.

The charging method of the present invention does not simultaneously charge a plurality of batteries 1, but rather successively switches the battery 1 being charged and charges batteries 1 one at a time with constant current. It means that the charging method of the present invention charges batteries 1 one by one.

Batteries 1 are charged with constant current until battery voltage reaches the prescribed voltage, or until remaining battery capacity reaches the prescribed capacity. Subsequently, batteries 1 are charged to full charge with voltage limited charging. Since charging current is high for constant current charging, batteries 1 are charged one at a time. Since charging current gradually decreases in voltage limited charging, a plurality of batteries 1 can also be charged simultaneously when charging current becomes small. When a plurality of batteries 1 are charged simultaneously, the control circuit 7 turns both the first switch 2A and the second switch 2B ON.

In constant current charging, the constant current, voltage limited charging circuit 6 charges a battery 1 while maintaining a fixed charging current. In voltage limited charging, batteries 1 are charged with constant voltage charging. Constant voltage charging charges batteries 1 to full charge by controlling charging current to keep battery voltage from exceeding a regulated voltage. However, in the present invention, voltage limited charging is not limited to constant voltage charging. During voltage limited charging by the constant current, voltage limited charging circuit 6, the voltage detection circuit 3 detects battery voltage, and charging can be according to any method which controls charging current and charging conditions to keep battery voltage from exceeding the regulated voltage. For example, while detecting battery voltage and keeping battery voltage from exceeding the regulated voltage, batteries 1 can also be pulse charged to full charge. The regulated voltage can be equal to the prescribed voltage used to end constant current charging, or it can also be less than, or greater than the prescribed voltage. The regulated voltage is set to a voltage that results in no battery performance degradation when batteries 1 are charged to full charge while regulating battery voltage to that value.

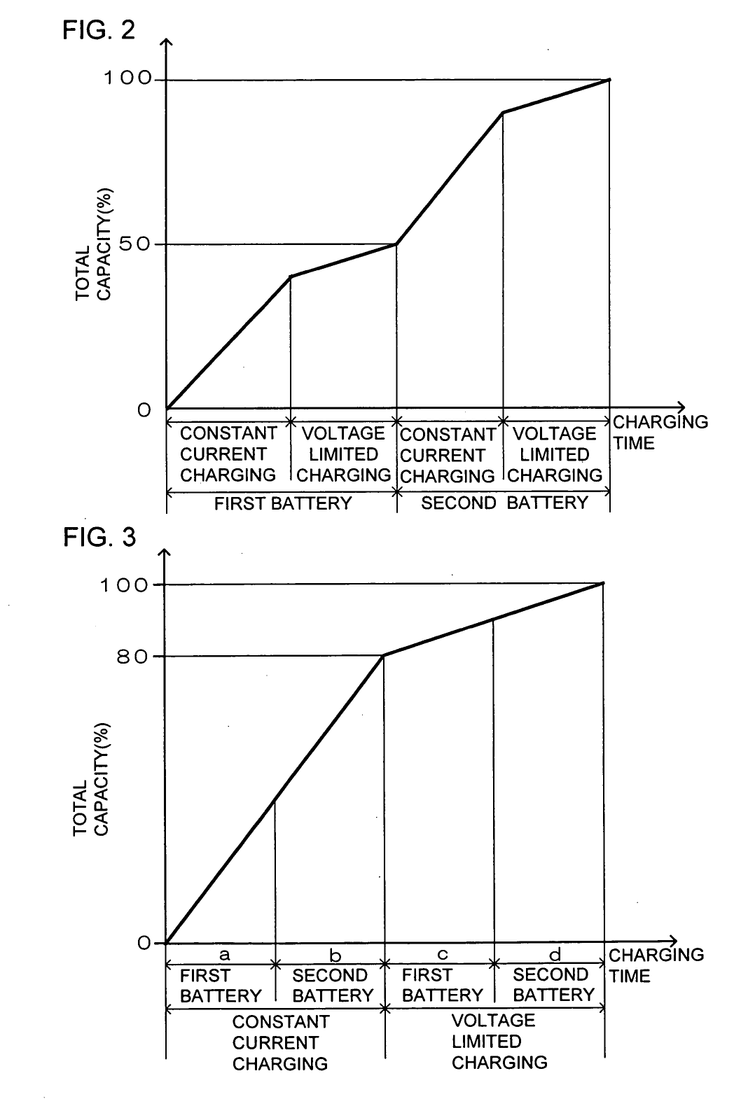

FIG. 2 is graph showing increase in battery capacity as a function of charging time. However, this graph does not show the state of charge for two batteries charged by the method of the present invention, but rather shows the state of charge when one battery is charged to full charge, the battery being charged is switched, and subsequently the next battery is charged to full charge. As shown in this graph, the capacity to which a battery can be charged in a given time changes for constant current charging and for voltage limited charging. Since constant current charging charges with a fixed current regardless of battery voltage, charge capacity over a given time interval is large. Since voltage limited charging limits charging current to keep battery voltage from exceeding the regulated voltage, charge capacity over a given time interval becomes small. In particular, as a battery approaches full charge, charge capacity for a given time interval becomes small. Consequently, if the time to charge one battery to full charge is two hours, four hours are required to charge two batteries to full charge. Further, for two batteries starting charging from a state of complete discharge, one battery is fully charged after two hours. Therefore, if the total capacity for both batteries is 100%, two hours of charging has resulted in a capacity which is 50% of the total.

FIG. 3 is a graph showing charging characteristics for two batteries 1 charged by the method of the present invention. In this figure, the horizontal axis is time and the vertical axis is total capacity. As shown in this graph, when the voltage of the first battery to be charged, which is the first battery 1A, is less than the prescribed voltage, the method of the present invention charges that battery with constant current charging until its voltage reaches the prescribed voltage (region a of FIG. 3). When the voltage of the battery being charged by constant current reaches the prescribed voltage, the battery being charged is switched, and the next battery, which is the second battery 1B, is charged by constant current until its voltage reaches the prescribed voltage (region b of FIG. 3).

Although FIG. 3 shows charging of two batteries, the case for three or more batteries is similar. For three or more batteries, the battery being charged by constant current is successively switched, and all batteries are charged to the prescribed voltage. Subsequently, charging conditions are changed from constant current charging to voltage limited charging, and all batteries are charged to full charge.

In FIG. 3, first the first battery 1A is charged to full charge by voltage limited charging (region c of FIG. 3), and subsequently the second battery 1B is charged to full charge by voltage limited charging (region d of FIG. 3) to fully charge all batteries 1. Although FIG. 3 shows voltage limited charging to full charge for two batteries, a method which charges three or more batteries switches the battery being charged as each battery reaches full charge, and successively charges all batteries to full charge by voltage limited charging. Further, although not illustrated, as the charging current for voltage limited charging decreases, a plurality of batteries can also be connected in parallel and simultaneously charged to full charge.

FIG. 3 shows initial rapid increase in the total capacity of the two batteries 1. Specifically, this graph shows the batteries 1 can be charged to 80% of the total capacity of both batteries 1 in half the time required to fully charge both batteries 1. This is because the second battery 1B can be efficiently charged by constant current charging during the time interval that the first battery 1A is being charged by voltage limited charging in the graph of FIG. 2.

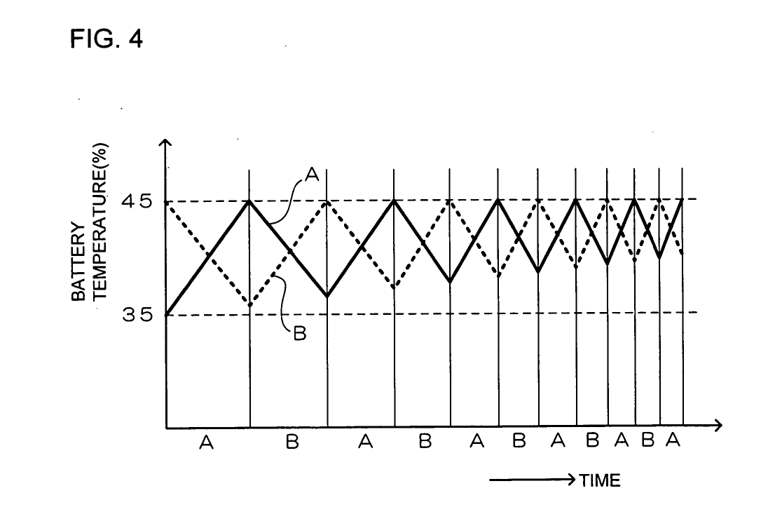

FIG. 4 shows switching between, and charging of two batteries A, B while monitoring their temperature. In this figure, when the temperature of the battery being charged rises to a maximum temperature, which is 45° C., the battery being charged is switched from battery A to battery B or from battery B to battery A. Charging is suspended to a battery with a temperature reaching the maximum temperature, and its temperature gradually drops. Subsequently, whenever the temperature of the battery being charged rises to the maximum temperature, the battery A, B being charged is switched. When a plurality of batteries are charged in this manner, battery temperature remains below the maximum temperature, and performance degradation due to batteries reaching high temperatures is prevented. The temperature of batteries rises easily during constant current charging steps. This is because the charging current is high. Consequently, during constant current charging steps, the battery being charged is switched when its temperature reaches the maximum temperature, and battery temperature rise can be kept below the maximum temperature. However, during voltage limited charging steps, the battery being charged can be switched when its temperature reaches the maximum temperature, and degradation due to heat can be prevented.

In the power supply circuit of FIG. 1, the control circuit 7 controls the first switch 2A and the second switch 2B to discharge the first battery 1A and the second battery 1B in order, and supply power to the load, which is battery powered electrical equipment 9. When the remaining capacity of the discharging battery 1 supplying power to the electrical equipment 9 drops below a minimum capacity, or battery voltage drops below a minimum voltage, power is supplied to charge the battery 1 supplying power to the electrical equipment 9 from another battery 1 with remaining capacity greater than the minimum capacity or voltage greater than the minimum voltage.

For example, the second switch 2B is OFF and the first switch 2A is ON to make the battery being discharged the first battery 1A. When remaining capacity of the first battery 1A drops below the minimum capacity, or the voltage of the first battery 1A drops below the minimum voltage, the control circuit 7 turns the first switch 2A and the second switch 2B ON to charge the first battery 1A with the second battery 1B. However, at this time, the control circuit 7 determines whether or not the remaining capacity of the second battery 1B is greater than the minimum capacity, or whether or not the voltage of the second battery 1B is greater than the minimum voltage. Only if the remaining capacity is greater than the minimum capacity, or the battery voltage is greater than the minimum voltage, does the control circuit 7 turn the first switch 2A and the second switch 2B ON to charge the first battery 1A with the second battery 1B. When both the first switch 2A and the second switch 2B are switched ON, charging current flows from the second battery 1B to the first battery 1A to charge the first battery 1A because remaining capacity of the first battery 1A is less than the second battery 1B, or voltage of the first battery 1A is less than the second battery 1B.

The charge capacity transferred by charging the first battery 1A with the second battery 1B is the capacity required to switch from the first battery 1A to the second battery 1B, or a predetermined minimum usable capacity that allows the first battery 1A to turn the battery powered electrical equipment 9 OFF. When the second battery 1B charges the first battery 1A, which is the discharging battery, with minimum usable capacity, the control circuit 7 turns the second switch 2B OFF and suspends charging of the first battery 1A.

A power supply circuit, which charges the first battery 1A to the minimum usable capacity in the manner described above, is properly used in the following fashion.
(1) The first switch 2A and the second switch 2B are switched ON, and the first battery 1A is charged to the minimum usable capacity.
(2) If an AC adapter is connected to the battery powered electrical equipment 9 in this state, charging of the first battery 1A will begin. In this state, the second switch 2B will be OFF and the second battery 1B will not be charged.

(3) If the AC adapter is disconnected before sufficient charging of the first battery 1A, power will be supplied to the electrical equipment 9 via the first switch 2A. If remaining capacity of the first battery 1A is low at this time, power will not be able to be supplied to the electrical equipment 9 before switching from the first battery 1A to the second battery 1B, and electrical equipment 9 such as a laptop computer will shut-down. However, since the first battery 1A was charged with minimum usable capacity from the second battery 1B, the first battery 1A will supply power to the electrical equipment 9 until it is switched to the second battery 1B. Therefore, electrical equipment 9 such as a laptop computer does not shut-down, and the first battery 1A is switched to the second battery 1B.
(4) Subsequently, power is supplied to the battery powered electrical equipment 9 from the second battery 1B.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within the meets and bounds of the claims or equivalence of such meets and bounds thereof are therefore intended to be embraced by the claims.

This application is based on application No. 2003-155708 filed in Japan on May 30, 2003, the content of which is incorporated hereinto by reference.

1. A method of charging a plurality of batteries which includes a step to successively switch to, and charge each of a plurality of batteries one at a time, wherein batteries are charged by constant current until battery voltage reaches a prescribed voltage, and subsequently batteries are charged by voltage limited charging while regulating battery voltage; and characterized in that
if the voltage of the first battery to be charged is less than the prescribed voltage, it is charged by constant current until the prescribed voltage is reached, when voltage of the battery being charged by constant current reaches the prescribed voltage, the battery being charged is switched, the next battery is charged by constant current until the prescribed voltage is reached, the battery being charged by constant current is switched from one to the next, and all batteries are charged to the prescribed voltage; and
subsequently, battery charging conditions are changed from constant current charging to voltage limited charging, and batteries are charged to full charge.

2. A method of charging a plurality of batteries as recited in claim 1 wherein battery temperature is detected, and if battery temperature reaches a maximum temperature, the battery being charged is switched.

3. A method of charging a plurality of batteries as recited in claim 1 wherein the batteries being charged are lithium ion batteries.

4. A method of charging a plurality of batteries as recited in claim 1 wherein the prescribed voltage for switching from constant current charging to voltage limited charging is 4.1V to 4.3V.

5. A method of charging a plurality of batteries as recited in claim 1 wherein if charging is switched to voltage limited charging and current decreases, a plurality of batteries are connected in parallel and charged.

6. A method of charging a plurality of batteries as recited in claim 1 wherein voltage limited charging is constant voltage charging.

7. A method of charging a plurality of batteries as recited in claim 1 wherein voltage limited charging is a method of controlling charging current and charging conditions to keep battery voltage from exceeding a regulated voltage.

8. A method of charging a plurality of batteries as recited in claim 1 wherein voltage limited charging is a method of charging which pulse charges while monitoring battery voltage and keeping battery voltage from exceeding a regulated voltage.

9. A method of charging a plurality of batteries which includes a step to successively switch to, and charge each of a plurality of batteries one at a time, wherein batteries are charged by constant current until remaining battery capacity reaches a prescribed capacity, and subsequently batteries are charged by voltage limited charging while regulating battery voltage; and characterized in that
if the remaining capacity of the first battery to be charged is less than the prescribed capacity, it is charged by constant current until the prescribed capacity is reached, when remaining capacity of the battery being charged by constant current reaches the prescribed capacity, the battery being charged is switched, the next battery is charged by constant current until the prescribed capacity is reached, the battery being charged by constant current is switched from one to the next, and all batteries are charged to the prescribed capacity; and
subsequently, battery charging conditions are changed from constant current charging to voltage limited charging, and batteries are charged to full charge.

10. A method of charging a plurality of batteries as recited in claim 9 wherein battery temperature is detected, and if battery temperature reaches a maximum temperature, the battery being charged is switched.

11. A method of charging a plurality of batteries as recited in claim 9 wherein the batteries being charged are lithium ion batteries.

12. A method of charging a plurality of batteries as recited in claim 9 wherein the remaining capacity for switching from constant current charging to voltage limited charging is 60% to 85% of full charge capacity.

13. A method of charging a plurality of batteries as recited in claim 9 wherein if charging is switched to voltage limited charging and current decreases, a plurality of batteries are connected in parallel and charged.

14. A method of charging a plurality of batteries as recited in claim 9 wherein voltage limited charging is constant voltage charging.

15. A method of charging a plurality of batteries as recited in claim 9 wherein voltage limited charging is a method of controlling charging current and charging conditions to keep battery voltage from exceeding a regulated voltage.

16. A method of charging a plurality of batteries as recited in claim 9 wherein voltage limited charging is a method of charging which pulse charges while monitoring battery voltage and keeping battery voltage from exceeding a regulated voltage.

17. A method of charging a plurality of batteries which includes a step to successively switch to, and charge each of a plurality of batteries one at a time; and characterized in that
charging of the first battery to be charged is suspended before that battery reaches full charge, charging is switched to the next battery and charging of that battery is started, and thereby the battery being charged is switched from one to the next, and all batteries are charged to a state preceding full charge.

18. A method of charging a plurality of batteries as recited in claim 17 wherein battery temperature is detected, and if battery temperature reaches a maximum temperature, the battery being charged is switched.

19. A method of charging a plurality of batteries as recited in claim 17 wherein the batteries being charged are lithium ion batteries.

20. A method of charging a plurality of batteries as recited in claim 17 wherein the prescribed voltage for switching from constant current charging to voltage limited charging is 4.1V to 4.3V.

21. A method of charging a plurality of batteries as recited in claim 17 wherein if charging is switched to voltage limited charging and current decreases, a plurality of batteries are connected in parallel and charged.

22. A method of charging a plurality of batteries as recited in claim 17 wherein voltage limited charging is constant voltage charging.

23. A method of charging a plurality of batteries as recited in claim 17 wherein voltage limited charging is a method of controlling charging current and charging conditions to keep battery voltage from exceeding a regulated voltage.

24. A method of charging a plurality of batteries as recited in claim 17 wherein voltage limited charging is a method of charging which pulse charges while monitoring battery voltage and keeping battery voltage from exceeding a regulated voltage.

25. A method of discharging a plurality of batteries which successively discharges each of a plurality of batteries one at a time to supply power to battery powered electrical equipment; characterized in that
when the remaining capacity of the discharging battery supplying power to the battery powered electrical equipment becomes less than a minimum capacity, or battery voltage becomes less than a minimum voltage, power is supplied to charge the discharging battery supplying power to the battery powered electrical equipment from another battery with remaining capacity greater than the minimum capacity or battery voltage greater than the minimum voltage.

26. A method of discharging a plurality of batteries as recited in claim 25 wherein the batteries are lithium ion batteries.

27. A method of discharging a plurality of batteries as recited in claim 25 wherein the batteries are either nickel hydrogen batteries or nickel cadmium batteries.
